(19) United States
(12) Patent Application Publication
(10) Pub. No.: US 2014/0240607 A1
(43) Pub. Date: Aug. 28, 2014

(54) POWER STATE MANAGEMENT FOR SET-TOP BOXES

(71) Applicant: MICROSOFT CORPORATION, Redmond, WA (US)

(72) Inventors: Jeffery Truong, San Francisco, CA (US); Vyacheslav Leizerovich, Sunnyvale, CA (US); Vivienne Catherine Lee, Palo Alto, CA (US); Christopher Elliott Fry, San Francisco, CA (US); Paul Cooper, San Jose, CA (US)

(73) Assignee: Microsoft Corporation, Redmond, WA (US)

(21) Appl. No.: 13/773,666

(22) Filed: Feb. 22, 2013

(51) Int. Cl. H04N 5/63

(52) U.S. Cl. CPC H04N 5/63
USPC 348/730

(57) ABSTRACT

When a set-top box determines to enter a low-power state, the set-top box determines a wake-up time based on a recording schedule, a maintenance schedule, and a boot spread. Before transitioning to the low-power state, the set-top box sends a message to a schedule server with the wake-up time. The server provides services to many set-top boxes. The server uses a wake-up time schedule that includes the wake-up times for the set-top boxes that it services to determine if the wake-up time will create too much load for the server given the set-top boxes already scheduled to wake-up around the wake-up time. If the proposed wake-up time will not create too much load, the server may respond to the set-top box that the proposed wake-up is acceptable. If not, the server may propose a new wake-up time based on the schedule.

### BACKGROUND

Set-top boxes are popular devices for providing television services in households. The set-top boxes typically decode an encoded cable or satellite signal and provide services such as digital video recording (DVR). Because of their popularity, there is an interest in reducing the amount of power used by the set-top boxes when they are not in use. One solution is to have each set-top box enter a low-power state where all of the components of the set-top box are deactivated except a microcontroller in the front panel of the set-top box. The microcontroller can reactivate the components of the set-top box either when requested by a user (e.g., when the user presses a power button on the front of the set-top box or on a remote control), or at a scheduled time (e.g., when it is time to record a program).

While such a technique can reduce the power used by set-top boxes, there are associated drawbacks. First, when a set-top box transitions from the low-power state to the normal or operating power state, the set-top box may need to request metadata and other information such as schedule data from a remote server. Where the remote server services many set-top boxes, the requests may overload or overwhelm the remote server when many set-top boxes transition from the low-power state at the same time. Second, because the set-top boxes determine when they will transition from the low-power state back to the normal-power state based on their DVR schedules, they may remain in the low-power state for an extended period of time and may miss updates or scheduling information from the remote server.

### SUMMARY

When a set-top box determines to enter a low-power state, the set-top box determines a wake-up time based on a recording schedule. Before transitioning to the low-power state, the set-top box sends a message to a schedule server with the proposed wake-up time. The schedule server provides services to many set-top boxes. The schedule server uses a wake-up time schedule that includes the wake-up times for the set-top boxes that it services to determine if the proposed wake-up time will create too much load for the schedule server given the set-top boxes already scheduled to wake-up at or around the proposed wake-up time. If the proposed wake-up time will not create too much load, the schedule server may respond to the set-top box that the proposed wake-up is acceptable. If not, the schedule server may propose a new wake-up time based on the schedule. For example, the new wake-up time may be a few minutes before the original wake-up time. The schedule server may also propose a new wake-up time to ensure that the set-top box checks for revised program schedules or software updates. The schedule server may propose aborting the entering of a low-power state if the schedule server determines there is insufficient time from a current time to the new wake-up time.

In an implementation, a determination to transition to a first power state from a second power state is made by a computing device. The computing device is in the second power state. A time to transition back to the second power state from the first power state is determined by the computing device. A message that indicates the determined time is sent by the computing device. A message is received by the computing device. Based on the received message, the computing device either transitions to the first power state, or remains at the second power state.

In an implementation, a first message is received from a first computing device by a second computing device. The first message includes a first time when the first computing device will transition from a first power state to a second power state. Whether the first time is acceptable or not acceptable is determined by the second computing device. If the first time is not acceptable, a second time when the first computing device will transition from the first power state to the second power state is determined by the second computing device. A second message is sent to the first computing device by the second computing device. The second message includes the second time.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for scheduling wake-up times for set-top boxes;

FIG. 2 is a more detailed illustration of the set-top box and the schedule server;

FIG. 3 is an operational flow of an implementation of a method for scheduling a wake-up time by a set-top box;

FIG. 4 is an operational flow of an implementation of a method for scheduling a wake-up time by a schedule server;

FIG. 5 is an operational flow of an implementation of a method for determining if there are connected devices before transitioning to a low-power state; and

FIG. 6 shows an exemplary computing environment in which example embodiments and aspects may be implemented.

### DETAILED DESCRIPTION

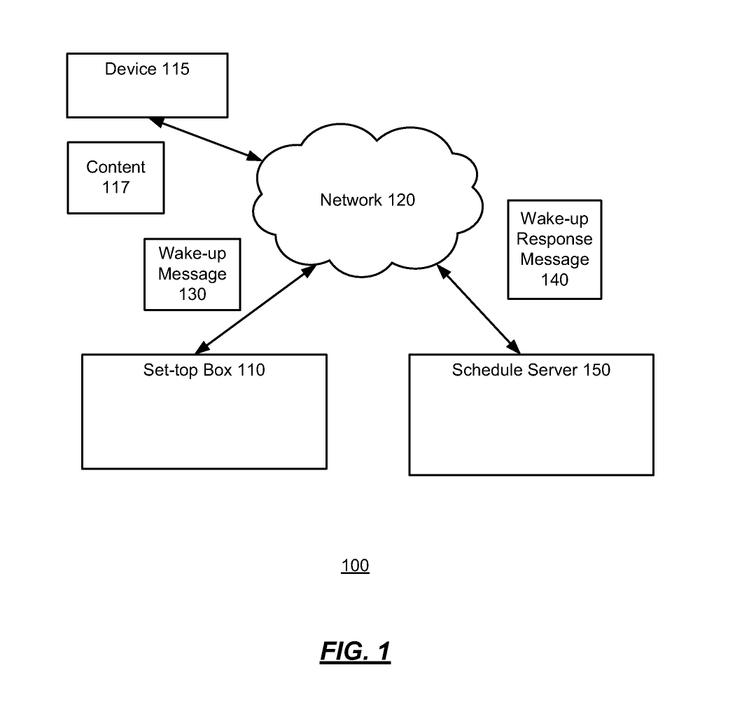

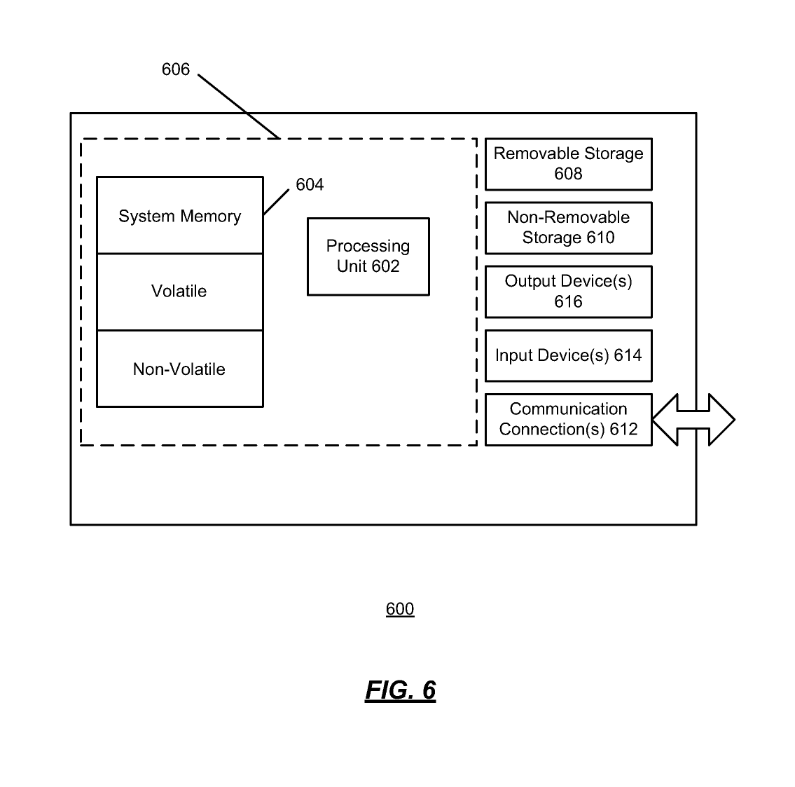

FIG. 1 is an illustration of an example environment 100 for scheduling wake-up times for set-top boxes. As illustrated, the environment 100 includes a set-top box 110, a device 115, and a schedule server 150 in communication with each other through a network 120. The network 120 may be a variety of network types including the public switched telephone network (PSTN), a cellular telephone network, and a packet switched network (e.g., the Internet or a cloud network). The device 115, the set-top box 110, and the schedule server 150 may be implemented using one or more general purpose computing devices such as the computing device 600 described with respect to FIG. 6, for example. Moreover, while only one device 115, one set-top box 110, and one schedule server 150 are shown in FIG. 1, it is for illustrative purposes only; there is no limit to the number of devices, set-top boxes, and/or schedule servers that may be supported.

The set-top box 110 may receive and decode content 117, and may present the decoded content 117 to a user or viewer. For example, the set-top box 110 may be a cable box and may receive and decode quadrature amplitude modulation (QAM) content 117 from a cable television provider, and may provide the decoded content 117 to a monitor or television connected to the set-top box 110. Other types of content 117 may be supported.

The set-top box 110 may include digital video recording (DVR) functionality. The DVR functionality may allow the set-top box 110 to record decoded content 117 to a hard drive or other storage device. The recorded content 117 may then be viewed at a later time by a user.

The set-top box 110 may provide content 117 to one or more devices 115. The devices 115 may include video-game systems, tablets, smart phones, computers, and even other set-top boxes 110. Other devices 115 may be supported. For example, a user of a device 115 may browse content 117 available from the set-top box 110, and may select the desired content 117 for viewing. The set-top box 110 may then stream or otherwise provide the selected content 117 to the device 115 through the network 120.

The content 117 that is provided by the set-top box 110 may not be limited to the content 117 that was recorded or decoded by the set-top box 110. The content 117 may include content 117 that is stored on a storage device such as a network attached storage device, or that is otherwise made available to the set-top box 110 through the network 120. In addition, the set-top box 110 may make online content 117 available to users of the devices 115. For example, the device 115 may use an interface provided by the set-top box 110 to request content 117 from one or more online content providers. The requested content may then be provided to the device 115 through the set-top box 110 by the online content providers.

The set-top box 110 may operate in one or more power states. Each power state may use a different amount of power and may support a different set of functions or operations. During normal operation (e.g., decoding, providing, or recording content 117), the set-top box 110 may be in what is referred to herein as a normal-power state. When using less power, the set-top box 110 may operate in what is referred to as a low-power state. During the low-power state, the set-top box 110 may not be able to decode, provide, or record content 117. During the low-power state, the set-top box 110 may use less than 1 watt of power; however, more or less power may be used.

The set-top box 110 may determine to transition from the normal-power state to the low-power state. The set-top box 110 may determine to transition when it does not have any scheduled recordings for some period of time, and no device 115 is connected to, or is receiving content 117 from, the set-top box 110. Before transitioning to the low-power state, the set-top box 110 may determine a time when the set-top box 110 will transition back to the normal-power state from the low-power state. The determined time is referred to herein as the wake-up time.

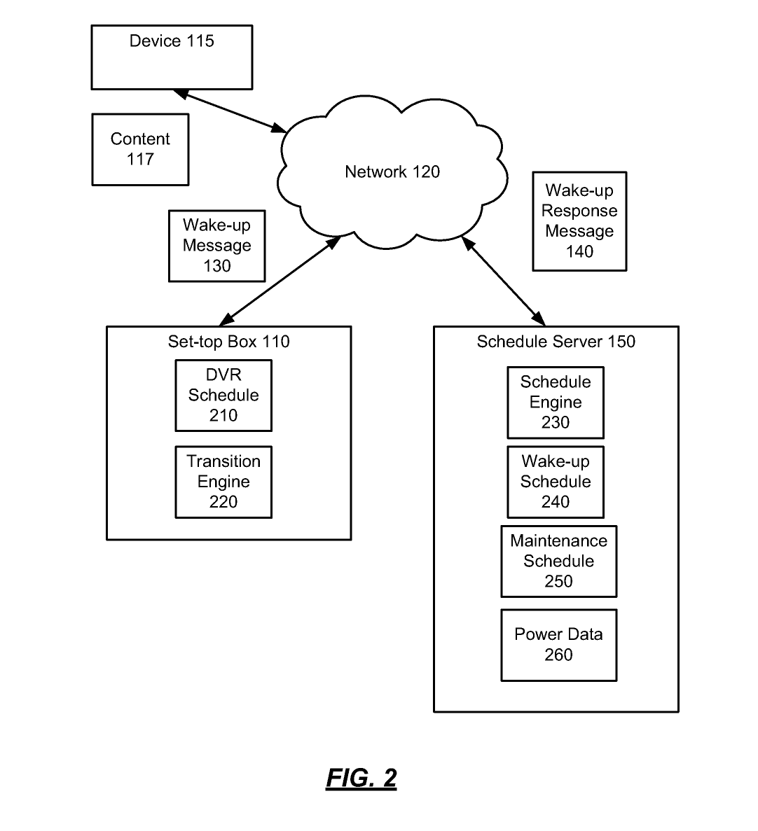

To avoid too many set-top boxes 110 transitioning back to the normal-power state or “waking up” at the same time, the environment 100 may include the schedule server 150. As described further with respect to FIG. 2, the set-top box 110 may provide the determined wake-up time to the schedule server 150 in a wake-up message 130. The wake-up message 130 may include an identifier of the set-top box 110 and the determined wake-up time.

The schedule server 150 may either allow the determined wake-up time, or may provide a new wake-up time for the set-top box 110. Whether or not the schedule server 150 allows the determined wake-up time may be determined based on the wake-up times of other set-top boxes 110 associated with the schedule server 150. The schedule server 150 may have finite network and computational resources and therefore may want to limit the number of set-top boxes 110 that wake-up at any particular time.

The schedule server 150 may indicate whether the original wake-up time is allowed, or may provide a new wake-up time, in a wake-up response message 140. The set-top box 110 may receive the message 140, may set the wake-up time based on the wake-up time indicated by the message 140, and may transition to the low-power state.

FIG. 2 is a more detailed illustration of the set-top box 110 and the schedule server 150. The set-top box 110 may include one or more components including a transition engine 220 and a DVR schedule 210. The schedule server 150 may include one or more components including a schedule engine 230, a wake-up schedule 240, a maintenance schedule 250, and power data 260. More or fewer components may be supported by the set-top box 110 and/or the schedule server 150. While the schedule engine 230, a wake-up schedule 240, and a maintenance schedule 250 are shown as being internal or part of the schedule server 150, in some implementations one or more of the components may be implemented separately from the schedule server 150.

The transition engine 220 may determine when the set-top 110 box may transition from the normal-power state to the low-power state. In some implementations, the transition engine 220 may determine to transition based on the DVR schedule 210. The DVR schedule 210 may include a list of the content 117 that the set-top box 110 is programmed to record along with the associated recording time. If the DVR schedule 210 indicates that no content 117 is to be recorded by the set-top box 110 for more than a threshold amount of time (e.g., one hour, two hours, five hours, etc.), then the transition engine 220 may determine that the set-top box 110 may transition to the low-power state. The threshold time may be set by a user or administrator.

In addition, the transition engine 220 may also consider whether there are any devices 115 that are connected to the set-top box 110, or that are receiving content 117 from the set-top box 110. If there are devices 115 that are connected and/or receiving content 117 from the set-top box 110, then the transition engine 220 may determine not to transition to the low-power state regardless of the DVR schedule 210. After the devices 115 have disconnected or have otherwise stopped receiving content 117 through the set-top box 110, the transition engine 220 may determine to transition to the low-power state.

In some implementations, before determining to transition to the low-power state, the transition engine 220 may wait a predetermined duration of time before determining to transition to the low-power state. If no devices 115 connect to, or request content 117 from, the set-top box 110 during the duration of time, the transition engine 220 may determine to transition to the low-power state. Waiting the duration of time may give any devices 115 that may have just completed using or viewing content 117 a chance to request additional content before the set-top box 110 transitions to the low-power state. The duration of time may be set by a user or administrator, for example.

After determining to transition to the low-power state, the transition engine 220 may determine a wake-up time when the set-top box 110 may transition back to the normal-power state from the low-power state. The transition engine 220 may determine the wake-up time based on the next scheduled recording in the DVR schedule 210. For example, if the next scheduled recording in the DVR schedule 210 is at 8 pm, the transition engine 220 may schedule the wake-up time as 8 pm or a few minutes before 8 pm.

In some implementations, the set-top box 110 may also consider a maintenance time when determining the wake-up time. The maintenance time may be a scheduled time for the set-top box 110 to connect to the schedule server 150, or another server, to receive program schedule updates or software updates. The maintenance time may be set by a user or administrator of the set-top box 110, or may have been provided by the schedule server 150 from the maintenance schedule 250. Where there is a maintenance time, the transition engine 220 may select the earliest of the maintenance time or the next scheduled recording time as the wake-up time.

Before transitioning to the low-power state, the transition engine 220 may generate a wake-up message 130 to send to the schedule server 150. The wake-up message 130 may identify the set-top box 110 (e.g., using a serial number or other identifier), and may include the determined wake-up time. The wake-up message 130 may be an XML message. Other message types and/or formats may be used.

After sending the wake-up message 130 to the schedule server 150, the set-top box 110 may wait for a wake-up response message 140 from the schedule server 150. In some implementations, the set-top box 110 may wait a predetermined duration of time. If no wake-up response message 140 is received, the transition engine 220 may transition to the low-power state and may plan to transition back to the normal-power state at the determined wake-up time. Alternatively, the transition engine 220 may resend the wake-up message 130 until a wake-up response message 140 is received.

The transition engine 220 may receive the wake-up response message 140 and may make take a variety of actions depending on the contents of the wake-up response message 140. Similarly to the wake-up message 130, the wake-up response message 140 may be an XML message.

If the wake-up response message 140 indicates that the proposed wake-up time is acceptable, the transition engine 220 may transition to the low-power state and may plan to transition back to the normal-power state at the proposed wake-up time. If the wake-up response message 140 indicates that the proposed wake-up time is not acceptable, and includes a new wake-up time, the transition engine 220 may transition to the low-power state and may plan to transition back to the normal-power state at the new wake-up time included in the wake-up response message 140.

In some implementations, the wake-up response message 140 may be what is referred to herein as a back-off message. The back-off message may include a flag or other indicator that tells the transition engine 220 to refrain from transitioning to the low-power state. In addition, the back-off message may indicate a time when the transition engine 220 may resend the wake-up message 130. Where the wake-up response message 140 is a back-off message, the transition engine 220 may remain in the normal-power state, and if applicable, may resend the wake-up message 130 to the schedule server 150 at the indicated time.

The schedule server 150 may service a plurality of set-top boxes 110. In some implementations the schedule server 150 may service set-top boxes 110 that are associated with a particular geographic region or location. For example, the schedule server 150 may service all set-top boxes 110 in a particular city or section of a city.

The schedule engine 230 of the schedule server 150 may receive wake-up messages 130 from set-top boxes 110 that are serviced by the schedule server 150. The schedule engine 230 may extract a proposed wake-up time from a wake-up message 130, and may generate a wake-up response message 140 based on the proposed wake-up time.

In some implementations, the schedule server 150 may generate the wake-up response message 140 from the proposed wake-up time and the wake-up schedule 240. The wake-up schedule 240 may be a schedule of the wake-up times for the set-top boxes 110 that are serviced by the schedule server 150. The schedule engine 230 may use load balancing techniques to ensure that the number of set-top boxes 110 that wake-up at a particular time does not overwhelm the capabilities of the schedule server 150. As described above, when a set-top box 110 wakes up, it typically contacts the schedule server 150 to receive programming schedules, software updates, and other information. Thus, each set-top box 110 may create a computing and network load on the schedule server 150.

Accordingly, in some implementations, the schedule engine 230 may use load balancing to determine whether the load on the schedule server 150 at the proposed wake-up time will not exceed a threshold capacity of the schedule server 150. The threshold capacity may be selected by a user or administrator and may be based on the networking and computing capabilities of the schedule server 150.

If the proposed wake-up time does not exceed the threshold capacity, then the schedule engine 230 may allow the proposed wake-up time and may add the proposed wake-up time to the wake-up schedule 240 for the set-top box 110. The schedule engine 230 may then generate a wake-up response message 140 that indicates that the proposed wake-up time is acceptable. Alternatively, the schedule engine 230 may do nothing, and the set-top box 110 may use the proposed wake-up time.

If the proposed wake-up time does exceed the threshold capacity, then the schedule engine 230 may use load balancing to select a new wake-up time based on the wake-up schedule 240. The wake-up time may be selected using load balancing and may be a time that is not already at capacity for the schedule server 150. The schedule engine 230 may add the new wake-up time to the wake-up schedule 240, and may generate a wake-up response message 140 that indicates the new wake-up time.

In some implementations, the new wake-up time may be randomly selected from a window of times that proceed the proposed wake-up time. For example, the window may be between 15 minutes and 1 minute before the proposed wake-up time. Other sized windows may be used. Generally, the more popular the proposed wake-up time is in the wake-up schedule 240, the larger the window. The size of the window and the number of set-top boxes waking up during the window is referred to herein as the boot spread.

The schedule engine 230 may further consider the maintenance schedule 250 when generating the wake-up response message 140. In some implementations, the schedule engine 230 may maintain the maintenance schedule 250 for each of the set-top boxes 110. The schedule 250 may indicate a time when each set-top box 110 may contact the schedule server 150 to receive maintenance such as schedules and software updates from the schedule server 150. When the schedule engine 230 considers a proposed wake-up time, it may determine if the maintenance time for the set-top box 110 is before the proposed wake-up time. If the maintenance time is after the proposed wake-up time, then the schedule engine 230 may allow the proposed wake-up time, or may further consider the proposed wake-up time using the wake-up schedule 240. If the maintenance time is before the proposed wake-up time, then the schedule engine 230 may not allow the proposed wake-up time, and may determine the maintenance time as the new wake-up time.

The schedule server 150 may further maintain the power data 260. The power data 260 may include an entry for each set-top box 110 and an indicator of how long the set-top box 110 is in the low-power state and/or how long the set-top box 110 is in the normal-power state. The time that each set-top box 110 is in each power state may be determined by the schedule server 150 based on the wake-up messages 130 and the wake-up times associated with each set-top box 110.

The schedule server 150 may use the power data 260 to provide a variety of power-related information. For example, in some implementations, the schedule server 150 may use the power data 260 to generate reports of the power usage of the set-top boxes 110 that it services. The data from the reports can be combined for all schedule servers 150. The reports may be used to comply with one or more energy or power related regulations, by showing the power used by the set-top boxes 110 for specified periods of time or date ranges.

The schedule server 150 may further receive DVR schedule requests from users associated with the set-top boxes 110. The schedule requests may be requests for a set-top box 110 associated with a user to record content 117 at a selected time and/or channel. The schedule server 150 may either accept the schedule requests and forward the requests to the associated set-top boxes 110, or may deny the schedule requests because the associated set-top box 110 is in the low-power state.

For example, a user may use a web page or other interface provided by the schedule server 150 to select content 117 for the set-top box 110 associated with the user to record. The schedule server 150 may determine, using the wake-up schedule 240, if the associated set-top box 110 is in the low-power state during the time associated with the selected content 117, and may either warn the user that the set-top box 110 cannot record the selected content 117 (because it is in the low-power state), or may determine to wake the set-top box 110 up at the time associated with the selected content 117. If the schedule server 150 determines that the associated set-top box 110 will not be in the low-power state at the associated time, the schedule server 150 may forward the request to the associated set-top box 110, or may queue the request to be sent to the set-top box 110 if the set-top box 110 is currently in the low-power state.

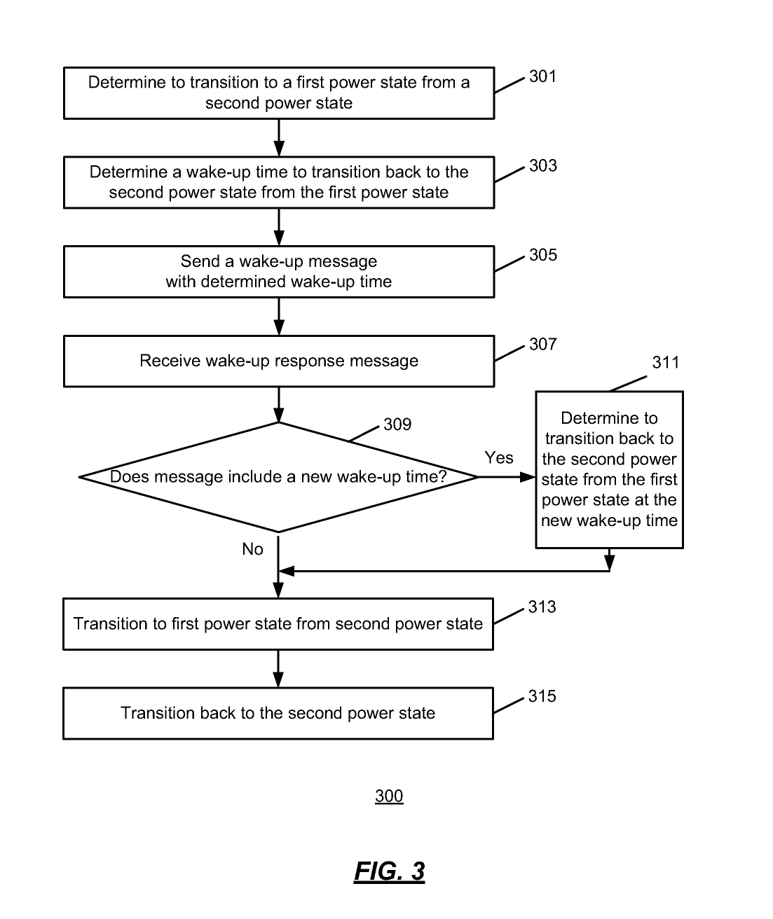

FIG. 3 is an operational flow of an implementation of a method 300 for scheduling a wake-up time by a set-top box. The method 300 may be implemented by a set-top box 110, for example.

A determination is made to transition to a first power state from a second power state at 301. The determination may be made by the transition engine 220 of the set-top box 110 based on a DVR schedule 210. The first power state may be a low-power state and the second power state may be a normal or operating-power state.

A wake-up time to transition back to the second power state from the first power state is determined at 303. The wake-up time may be determined by the transition engine 220 of the set-top box 110 based on the DVR schedule 210. For example, the wake-up time may be a time that is just before a next scheduled recording. The determined wake-up time may be used to program a microcontroller that may cause the set-top box 110 to transition back to the second power state at the wake-up time. The wake-up time may be further based on a boot spread determined using the wake-up schedule 240, and/or based on the maintenance schedule 250. The wake-up schedule 240 and/or the maintenance schedule 250 may be provided to the set-top box 110 by the schedule server 150.

A wake-up message with the determined wake-up time is sent at 305. The wake-up message 130 may be sent by the transition engine 220 of the set-top box 110 to the schedule server 150. The wake-up message 130 may identify the set-top box 110 and may include the determined wake-up time. The wake-up message 130 may be an XML message, for example.

A wake-up response message is received at 307. The wake-up response message 140 may be received from the schedule server 150 by the set-top box 110. The wake-up response message 140 may also be an XML message.

Whether the wake-up response message includes a new wake-up time is determined at 309. The determination may be made by the transition engine 220 of the set-top box 110. If the wake-up response message includes a new wake-up time, then the method 300 may continue at 311. Else, the method 300 may continue at 313.

A determination is made to transition back to the second power state from the first power state at the new wake-up time, at 311. The determination may be made by the set-top box 110 by re-programming the microcontroller with the new wake-up time, for example.

A transition is made from the second power state to the first power state, at the 313. The set-top box 110 may transition to the first power state (i.e., a low-power state) by powering down some or all of the components of the set-top box 110 with the exception of the microcontroller. Other methods for transitioning to a low-power state may be used.

A transition back to the second power state from the first power state is made at 315. The transition may be made by the set-top box 110 at either the original wake-up time that was determined at 303, or the new wake-up time determined at 309 depending on the wake-up response message 140. The set-top box 110 may transition back to the second power state by the microcontroller powering up some or all of the components of the set-top box 110 that were powered down at 313.

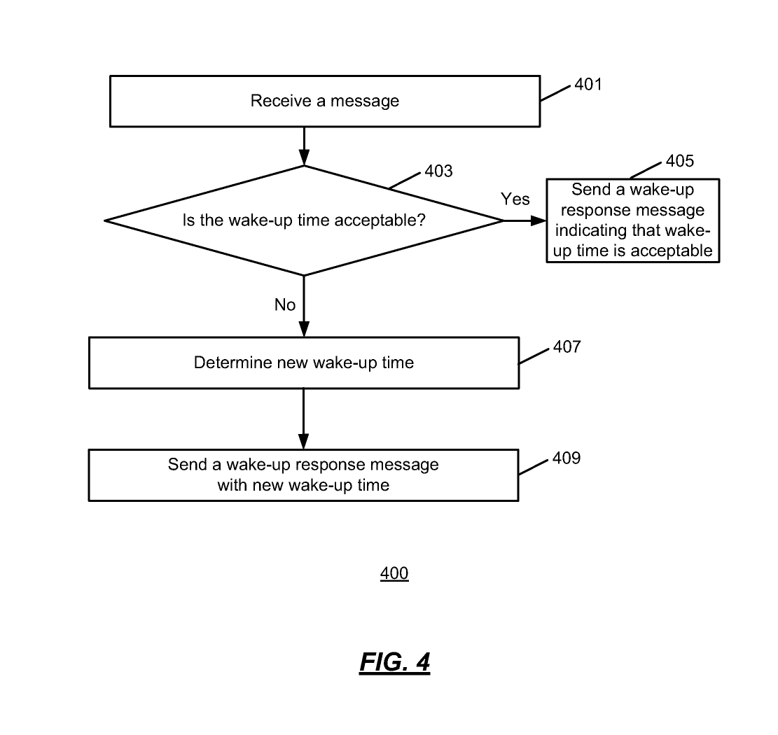

FIG. 4 is an operational flow of an implementation of a method 400 for scheduling a wake-up time. The method 400 may be implemented by the schedule server 150, for example.

A message is received at 401. The message may be a wake-up message 130 and may be received by the schedule engine 230 of the schedule server 150. The wake-up message 130 may identify a set-top box 110, and may include a proposed wake-up time when the identified set-top box 110 may transition back from a low-power state to a normal-power state. The message 130 may be an XML message.

Whether the wake-up time is acceptable is determined at 403. The determination may be made by the schedule engine 230 of the schedule server 150 using a wake-up schedule 240. The wake-up schedule 240 may include the scheduled wake-up times of a plurality of set-top boxes 110 that are serviced by the schedule server 150. In some implementations, the schedule engine 230 may determine that the proposed wake-up time is acceptable if the load on the schedule server 150 does not exceed a threshold load for the schedule server 150 when the proposed wake-up is included in the wake-up schedule 240. As described previously, when a set-top box 110 transitions back to the normal-power state from the low-power state, it communicates with the schedule server 150 to receive schedule and software updates, resulting in a load on the schedule server 150. If the load is not greater than the threshold (i.e., the wake-up time is acceptable), then the method 400 may continue at 405. Else, the method 400 may continue at 407.

A wake-up response message indicating that the proposed wake-up time is acceptable is sent at 405. The wake-up response message 140 may be sent by the schedule engine 230 of the schedule server 150 to the set-top box 110 that sent the wake-up message 130. In addition, the schedule engine 230 may add the wake-up time to the wake-up schedule 240. Alternatively, in some implementations, when the wake-up time is acceptable the schedule server 150 may send no wake-up response message 140. The set-top box 110 may then proceed with the proposed wake-up time if no wake-up response message 140 is received within a threshold duration of time.

A new wake-up time is determined at 407. The new wake-up time may be determined by the schedule engine 230 of the schedule server 150 based on the wake-up schedule 240. For example, the schedule engine 230 may use load balancing to select a new wake-up time that is close to the proposed wake-up time but that is not already scheduled for a large number of other set-top boxes 110 in the schedule 240.

A wake-up response message is sent at 409. A wake-up response message 140 may be sent by the schedule engine 230 of the schedule server 150. The wake-up response message 140 may include the determined new wake-up time.

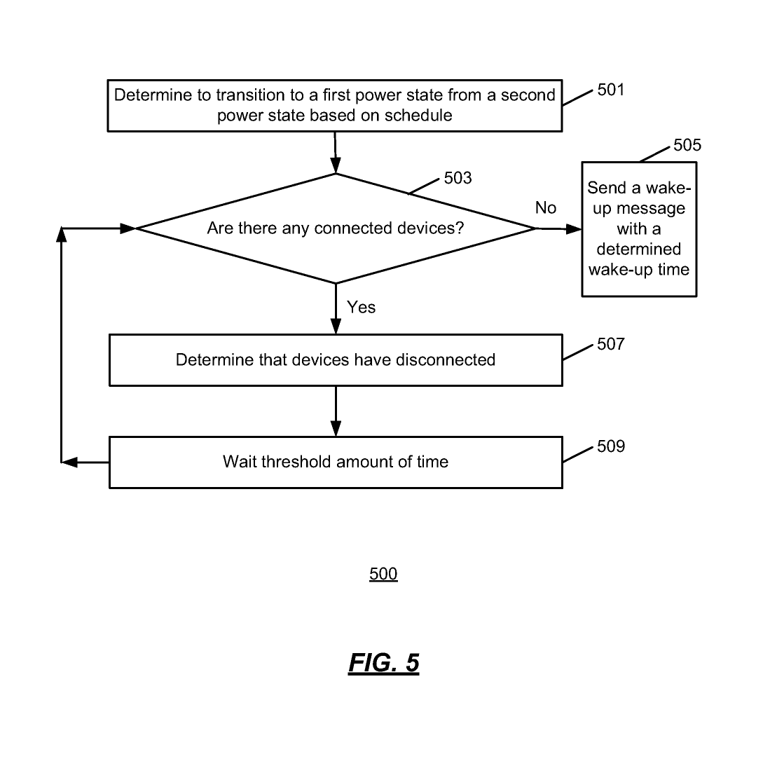

FIG. 5 is an operational flow of an implementation of a method 500 for determining if there are connected devices before transitioning to a low-power state. The method 500 may be implemented by the set-top box 110, for example.

A determination is made to transition to a first power state from a second power state at 501. The determination may be made by the transition engine 220 of the set-top box 110 based on the DVR schedule 210. For example, if no program is scheduled to be recorded in the next two hours, the transition engine 220 may determine to transition to the first power state from the second power state. The first power state may be a low-power state, and the second power state may be a normal or high-power state.

Whether there are any connected devices is determined at 503. Whether there are any connected devices 115 to the set-top box 110 may be determined by the transition engine 220. The connected devices 115 may be selecting and/or receiving content 117 from the set-top box 110. If there are any connected devices 115, then the method 500 may continue at 507. Else, the method may continue at 505.

A wake-up message with a determined wake-up time is sent at 505. The wake-up message 130 may be sent by the set-top box 110 to the schedule server 150. Because there were no detected devices 115, the set-top box 110 may determine to transition to the first power state as planned. After the set-top box 110 receives a wake-up response message 140 (or after a predetermined amount of time passes without receiving a wake-up response message 140), the set-top box 110 may transition to the first power state from the second power state.

A determination that the connected devices have disconnected is made at 507. The determination may be made by the transition engine 220 of the set-top box 110.

A threshold amount of time is waited at 509. The threshold amount of time is waited by the transition engine 220 of the set-top box 110. The threshold amount of time is selected such that any user of a previously connected device 115 has a chance to select or view additional content 117 from the set-top box 110 after the device 115 is disconnected. The threshold amount of time may be set by a user or administrator, for example. After waiting the threshold amount of the time, the method 500 may return to 503 where the transition engine 220 may re-determine whether there are any connected devices.

FIG. 6 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), smart phones, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an exemplary system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610. Computing device 600 typically includes a variety of computer readable media. Computer readable media can be any available media that can be accessed by device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communications connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
determining to transition to a first power state from a second power state by a computing device, wherein the computing device is at the second power state;
determining a first time for the computing device to transition back to the second power state from the first power state by the computing device;
sending a first message that indicates the determined first time by the computing device;
receiving a second message by the computing device; and
based on the received second message, either transitioning to the first power state, or remaining at the second power state by the computing device.

2. The method of claim 1, wherein the first power state is a low-power state.

3. The method of claim 1, wherein the computing device is a set-top box or a digital video recorder.

4. The method of claim 1, wherein the second message indicates that the computing device is to remain in the second power state, and further indicates a time when the computing device may resend the first message.

5. The method of claim 1, wherein the first time is determined based on a recording schedule and a maintenance schedule.

6. The method of claim 1, wherein the received second message includes a second time, and further comprising transitioning to the second power state from the first power state at the second time.

7. The method of claim 1, wherein determining to transition to the first power state from the second power state comprises:
determining if there are one or more devices connected to the computing device; and
if it is not determined that there are one or more devices connected to the computing device, determining to transition to the first power state from the second power state.

8. The method of claim 7, further comprising if it is determined that there are one or more devices connected to the computing device:
determining that the one or more devices have disconnected from the computing device;
determining that a threshold amount of time has elapsed since it was determined that the one or more devices have disconnected from the computing device; and
in response to determining that the threshold amount of time has elapsed since it was determined that the one or more devices have disconnected from the computing device, determining to transition to the first power state from the second power state.

9. A method comprising:
receiving a first message from a first computing device by a second computing device, wherein the first message includes a first time when the first computing device will transition from a first power state to a second power state;
determining if the first time is acceptable or not acceptable by the second computing device;
in response to determining that the first time is not acceptable, determining a second time when the first computing device will transition from the first power state to the second power state by the second computing device, wherein the second time is selected from a window of times that proceed the first time; and
sending a second message to the first computing device by the second computing device, wherein the second message includes the second time.

10. The method of claim 9, wherein the first power state is a low-power state.

11. The method of claim 9, further comprising recording when the first computing device is in the first power state.

12. The method of claim 9, further comprising:
in response to determining that the first time is acceptable, sending a third message to the first computing device by the second computing device, wherein the third message indicates that the first time is acceptable.

13. The method of claim 9, wherein determining if the first time is acceptable or not acceptable by the second computing device comprises determining if the first time is acceptable or not acceptable using a schedule, wherein the schedule comprises indicators of a plurality of wake-up times for a plurality of computing devices.

14. The method of claim 13, wherein determining the second time comprises determining the second time using a load balancing function and the schedule.

15. The method of claim 13, wherein the schedule further comprises indicators of a plurality of maintenance times for the plurality of computing devices.

16. The method of claim 13, wherein the second computing device includes a capacity and determining if the first time is acceptable or not acceptable by the second computing device comprises determining if the first time is acceptable or not acceptable using the schedule and the capacity.

17. A system comprising:
a set-top box adapted to:
determine to transition to a low-power state from a normal-power state, wherein the set-top box is at the normal-power state;
determine a first wake-up time to transition back to the normal-power state from the low-power state; and
send a first message that indicates the first wake-up time; and
a schedule server adapted to:
receive the first message from the set-top box;
determine if the first wake-up time is acceptable or not acceptable;
in response to determining that the first wake up time is not acceptable, determine a second wake-up time, wherein the second-wake up time is selected from a window of times that proceed the first wake-up time; and
send a second message to the set-top box, wherein the second message includes the second wake-up time.

18. The system of claim 17, wherein the set-top box is further adapted to:
receive the second message from the schedule server;
transition to the low-power state from the normal-power state after receiving the second message from the schedule server; and
transition to the normal-power state from the low-power state at the second wake-up time.

19. The system of claim 17, wherein the set-top box determines the first wake-up time based on a maintenance schedule or a boot spread.

20. The system of claim 17, wherein the schedule server is further adapted to record when the set-top box is in the low-power state and the normal power state.
